(19) United States
(12) Patent Application Publication
(10) Pub. No.: US 2012/0061036 A1
(43) Pub. Date: Mar. 15, 2012

(54) Retractable window mat

(75) Inventor: Agbegnenou Desire Agbozouhoue, Las Vegas, NV (US)

(73) Assignee: AGBEGNENOU DESIRE AGBOZOUHOUE

(21) Appl. No.: 13/134,387

(22) Filed: Jun. 7, 2011

Related U.S. Application Data
(60) Provisional application No. 61/381,362, filed on Sep. 9, 2010.

(51) Int. Cl. E06B 9/68

(52) U.S. Cl. 160/309

(57) ABSTRACT

A method and mechanism for allowing a Retractable Window Mat to help car drivers avoid blinding effects of direct sunlight, to protect furnishings and occupants inside home from UV Rays and keep items inside a home or car from outside passerby. Broadly, embodiments of the present invention generally provide a window mat that comprises a film or mat, a guide, housing, a drive motor and a control. Princedez Window Tint Mat can be deployed during the day and retracted at night, giving the same protection as regular window tinting without its permanence. Effectiveness is easy with Princedez Window Tint Mat because it's controlled manually or by remote. It ease of use and convenience for commercial, residential, outdoor, solar panels manufacturer and advertising customers around the world makes it a great and unique invention.

### BRIEF DESCRIPTION OF THE DRAWINGS

FIG. 1 is a partial perspective view of a window mat according to an embodiment of the present invention installed on a rear window of a car; and FIG. 2 is partial perspective view of the window mat apparatus of FIG. 1 according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. Broadly, embodiments of the present invention generally provide a window mat that comprises a film or mat, a guide, housing, and a control.

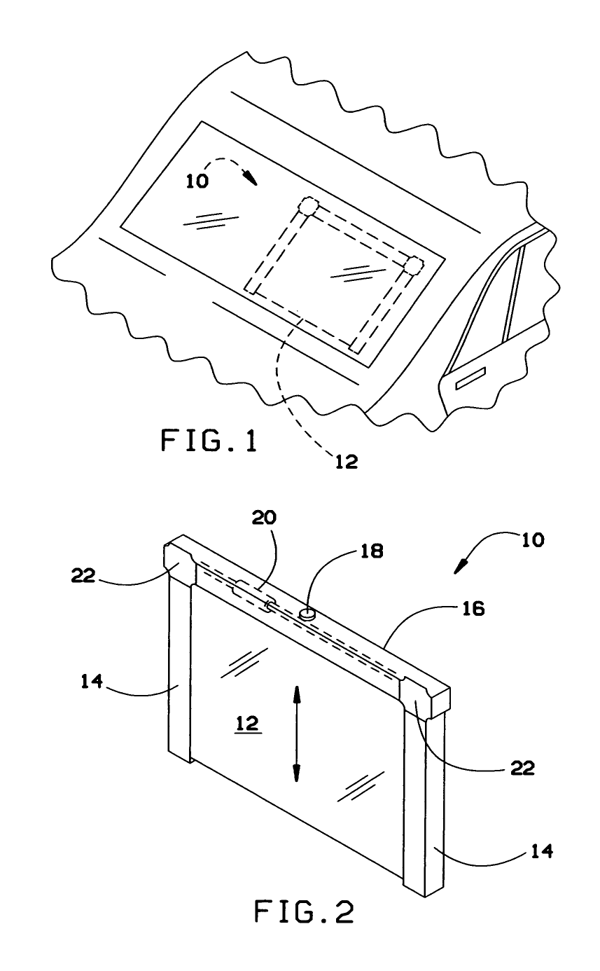

Referring now to FIG. 1, a partial elevation view is shown of a window mat 10 installed on the rear window of an automobile. In this embodiment, the window mat 10 is shown with film 12 deployed.

Window mat 10 may also be installed on any of the passenger windows, driver windows, side windows, moon roof, or windshield. In other embodiments of the present invention, mat 10 may be used in installations including, for example, a home window, a skylight, a greenhouse, a glass door, and any other translucent or transparent surface.

Mat 10 may also be used to span empty spaces to act, for example, as a privacy screen, advertising banner, projection screen, or display.

Referring now to FIG. 2, a partial perspective view of a window mat 10 according to an embodiment of the present invention is shown. Film 12 may be a flexible film or screen. Film 12 may be transparent, translucent, opaque, or reflective, and may be, for example, a continuous material, a perforated material, a fabric, a woven material, a laminate, or a composite material.

In other embodiments of the present invention, film 12 may also be a display such as, for example, an organic LED display, a LCD display, a matrix display, or a fluorescent screen.
Film 12 may have an image or design printed onto it or woven into it.
Film 12 may also be a material used to collect or transform energy such as, for example, a solar panel.

Guide 14 is a durable channel that may be rigidly attached on one end to housing 16, and may allow film 12 to slide longitudinally along the length of guide 14. Film 12 may be situated between guides 14, which may be located on either side of film 12. Guide 14 may hold film 12 in place continuously along the portion of guide 14 that may engage film 12. In another embodiment, guide 14 may hold film 12 in place discontinuously along the portion of guide 14 that may engage film 12. In yet another embodiment, film 12 may be joined to a member that may be held by guide 14 by at least one point.

Guide 14 may have a locking system or mechanism that may selectively hold film 12 in a deployed, partially deployed, or retracted position.

Housing 16 may be a container housing windup device 20, and having at least one Mount 22 located at any point on its exterior surface. Mount 22 may be used to secure the mat 10 to a surface, and may comprise any device well known in the art to secure two surfaces including, for example, a suction cup, an adhesive, an epoxy, a hook and loop fastener, a static cling fastener, a magnet, a weld, a rivet, and a fastener such as a screw, bolt or nut.

Windup device 20 may be any of a number of devices well known in the art that may rotatably deploy or retract film 12 including, for example, a motor, a spring, a torsion device, and a pneumatic cylinder. Windup device 20 may be mounted on, or in communication with a shaft or roller onto which film 12 may wind. Control 18 may be any number of control devices including, for example, a toggle switch, a sliding switch, a momentary contact switch, a photo sensor, a touch sensor, and a rocker switch.

Control 18 may be located on housing 16, and may be in communication with windup device 20. In one embodiment of the present invention, control 18 may selectively control retraction or deployment of film 12.
In another embodiment of the present invention, windup device 20 may mechanically store potential energy when film 12 is deployed or retracted, the potential energy being sufficient to subsequently retract or deploy film 12 respectively.
In another embodiment of the present invention, film 12 may have a handle or tab secured to an edge of film 12 opposite the housing 16. The handle or tab may be engaged by a user when manually deploying or retracting film 12.
In another embodiment of the present invention, control 18 may be an environmental sensor such as, for example, a photo sensor that may be designed to automatically deploy or retract film 12 when a particular lighting condition or environmental condition is detected by control 18.
In yet another embodiment of the present invention, control 18 may be connected to, or in communication with, a plurality of window mats 10.
In other embodiments of the present invention, control 18 may be separate from housing 16, and may remotely control deployment or retraction of film 12. Control 18 may be in communication with the window mat 10 or the windup device 20 in any number of ways including, for example, infrared signals, radio frequency signals, and direct wire.

It should be understood, of course, that the foregoing relates to exemplary embodiments of the invention and that modifications may be made without departing from the spirit and scope of the invention as set forth in the following claims.

We claim:

1 A window mat comprising:
A film, the film having at least one edge;
A guide, wherein the guide is configured to guide movement of at least a part of the at least one edge of the film longitudinally along a length of the guide;
A windup device, the windup device being capable of at least one of rotatably deploying or retracting the film;
A control, the control being in communication with the windup device and the control being capable of initiating the at least one of rotatably deploying or retracting the film; and
A housing, wherein the housing is configured to at least partially enclose the windup device and at least a portion of the film, and the guide is joined on one end to the housing.
